(19) United States
(12) Patent Application Publication
(10) Pub. No.: US 2010/0270951 A1
(43) Pub. Date: Oct. 28, 2010

(54) Fluorescent lamp Having Overheat Protection Function

(76) Inventor: Wen-Hsin Chao, Homei Town (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/430,328

(22) Filed: Apr. 27, 2009

(51) Int. Cl. H05B 37/02

(52) U.S. Cl. 315/309

(57) ABSTRACT

A fluorescent lamp includes a base, a control circuit mounted in the base, a fluorescent tube electrically connected with the control circuit, and a protection device electrically connected with the control circuit. Thus, when the temperature of the control circuit is raised excessively to reach a preset temperature value due to an overheat of the fluorescent tube, the protection device is operated to shut an electric power supplied to the control circuit so as to stop operation of the fluorescent tube and to prevent the control circuit from producing overheat, thereby protecting and preventing the control circuit from being worn out or broken due to an overheat.

### BACKGROUND OF THE INVENTION

1. Field of the Invention

The present invention relates to a lamp and, more particularly, to a fluorescent lamp to provide a lighting function.

2. Description of the Related Art

A conventional fluorescent lamp comprises a base, a control circuit mounted in the base, a fluorescent tube electrically connected with the control circuit, and a lamp shade mounted on the base to cover the fluorescent tube. The control circuit includes a rectifier and a power converter (or transformer). When in use, when the fluorescent lamp is electrified, an electric current from an external power supply in turn flows through the input terminal of the base, the rectifier of the control circuit, the power converter of the control circuit, and the fluorescent tube and flows outwardly from the output terminal of the base. At this time, when the electric current flows through the rectifier of the control circuit, the electric current is rectified and filtered by the rectifier of the control circuit to produce a stabilized direct current. In addition, when the electric current flows through the power converter of the control circuit, the power converter of the control circuit transforms the electric current from an alternating current into a direct current. In addition, when the electric current flows through the fluorescent tube, the fluorescent tube produces an arc discharging action to provide a lighting function.

In such a manner, when the fluorescent tube is aged or worn out during a long-term utilization, the impedance in the fluorescent tube is increased largely to produce a greater heat energy so that the temperature of the fluorescent tube is increased largely, and the temperature of the control circuit is also increased largely. However, when the temperature of the control circuit is raised excessively, the control circuit will produce overheat, so that the rectifier and the power converter of the control circuit are easily worn out or broken due to an overheat.

### BRIEF SUMMARY OF THE INVENTION

In accordance with the present invention, there is provided a fluorescent lamp, comprising a base, a control circuit mounted in the base, a fluorescent tube electrically connected with the control circuit, and a protection device electrically connected with the control circuit and operable to shut an electric power supplied to the control circuit when a temperature of the control circuit is raised to reach a preset temperature value so as to stop operation of the fluorescent tube.

The primary objective of the present invention is to provide a fluorescent lamp having an overheat protection function.

Another objective of the present invention is to provide a fluorescent lamp, wherein when the temperature of the control circuit is raised excessively to reach the preset temperature value due to an overheat of the fluorescent tube, the protection device is operated to interrupt the connection between the input terminal of the base and the control circuit and to shut the electric power supplied to the control circuit so as to stop operation of the fluorescent tube and to prevent the control circuit from producing overheat, thereby protecting and preventing the rectifier and the power converter of the control circuit from being worn out or broken due to an overheat.

A further objective of the present invention is to provide a fluorescent lamp, wherein the protection device can protect the control circuit to prevent the control circuit from being burned so as to protect the user's safety and to save the costs of maintenance.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is an exploded perspective view of a fluorescent lamp in accordance with the preferred embodiment of the present invention.

FIG. 2 is a circuit layout of the fluorescent lamp as shown in FIG. 1.

FIG. 3 is a circuit block diagram of the fluorescent lamp as shown in FIG. 1.

FIG. 4 is a circuit block diagram of a fluorescent lamp in accordance with another preferred embodiment of the present invention.

FIG. 5 is a circuit block diagram of a fluorescent lamp in accordance with another preferred embodiment of the present invention.

### DETAILED DESCRIPTION OF THE INVENTION

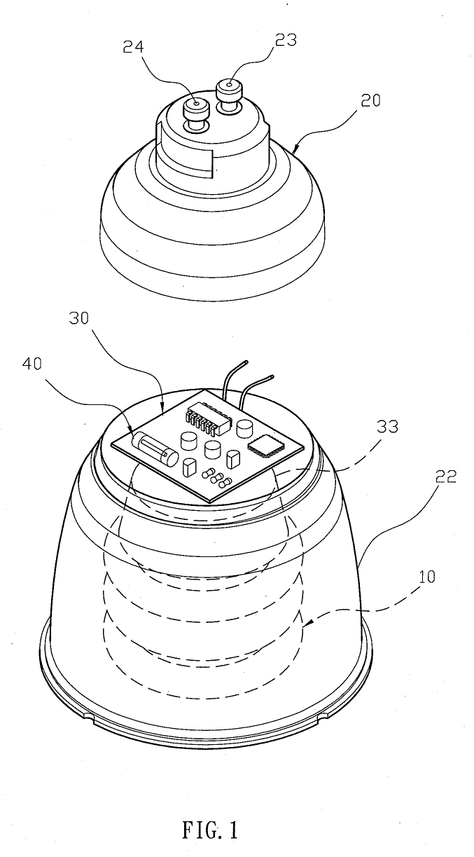

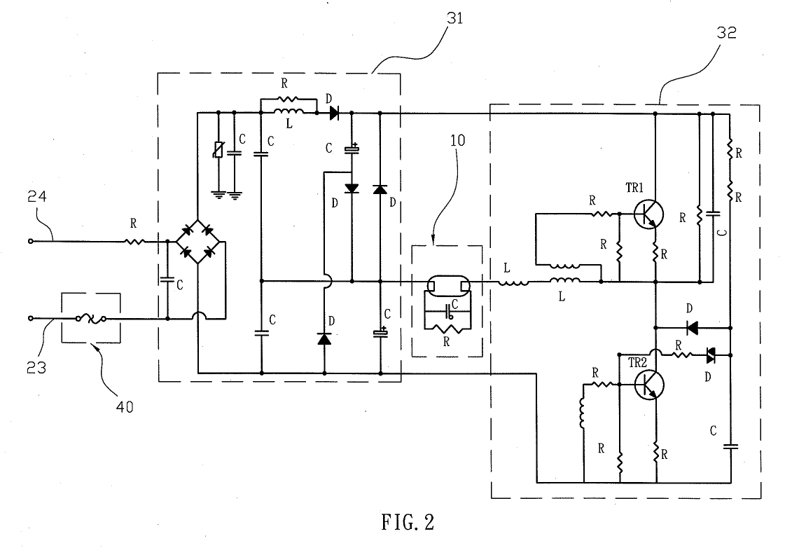

Referring to the drawings and initially to FIGS. 1-3, a fluorescent lamp in accordance with the preferred embodiment of the present invention comprises a base 20, a control circuit 30 mounted in the base 20, a fluorescent tube 10 electrically connected with the control circuit 30, and a protection device 40 electrically connected with the control circuit 30 and operable to shut an electric power supplied to the control circuit 30 when a temperature of the control circuit 30 is raised to reach a preset temperature value so as to stop operation of the fluorescent tube 10. The fluorescent lamp further comprises a lamp shade 22 mounted on the base 20 to cover the fluorescent tube 10.

The base 20 includes an input terminal 23 and an output terminal 24. The protection device 40 is electrically connected between the input terminal 23 of the base 20 and the control circuit 30. The control circuit 30 is electrically connected between the protection device 40 and the fluorescent tube 10. The fluorescent tube 10 is electrically connected between the control circuit 30 and the output terminal 24 of the base 20. The fluorescent tube 10 is mounted inside of the lamp shade 22. The control circuit 30 is mounted outside of the lamp shade 22 and is located between the lamp shade 22 and the base 20. The control circuit 30 has a connecting terminal 33 electrically connected with the fluorescent tube 10. The connecting terminal 33 of the control circuit 30 is mounted inside of the lamp shade 22. The control circuit 30 includes a rectifier 31 electrically connected with the protection device 40 and a power converter (or transformer) 32 electrically connected between the rectifier 31 and the fluorescent tube 10. The connecting terminal 33 of the control circuit 30 is electrically connected between the power converter 32 and the fluorescent tube 10.

The protection device 40 is mounted on the control circuit 30 and is located between the lamp shade 22 and the base 20. The protection device 40 is electrically connected between the input terminal 23 of the base 20 and the rectifier 31 of the control circuit 30. Preferably, the protection device 40 is a heat sensitive switch. The preset temperature value of the control circuit 30 is ranged between 115° C. and 130° C. Thus, when the temperature of the control circuit 30 is raised to reach the preset temperature value ranged between 115° C. and 130° C., the protection device 40 is operable to interrupt the connection between the input terminal 23 of the base 20 and the control circuit 30 and to shut the electric power supplied to the control circuit 30 so as to stop operation of the fluorescent tube 10.

When in use, when the fluorescent lamp is electrified, an electric current from an external power supply (not shown) in turn flows through the input terminal 23 of the base 20, the protection device 40, the rectifier 31 of the control circuit 30, the power converter 32 of the control circuit 30, the connecting terminal 33 of the control circuit 30 and the fluorescent tube 10 and flows outwardly from the output terminal 24 of the base 20. At this time, when the electric current flows through the rectifier 31 of the control circuit 30, the electric current is rectified and filtered by the rectifier 31 of the control circuit 30 to produce a stabilized direct current. In addition, when the electric current flows through the power converter 32 of the control circuit 30, the power converter 32 of the control circuit 30 transforms the electric current from an alternating current into a direct current. In addition, when the electric current flows through the fluorescent tube 10, the fluorescent tube 10 produces an arc discharging action to provide a lighting function.

In such a manner, when the fluorescent tube 10 is aged or worn out during a long-term utilization, the impedance in the fluorescent tube 10 is increased largely to produce a greater heat energy so that the temperature of the fluorescent tube 10 is increased largely, and the temperature of the control circuit 30 is also increased largely. Thus, when the temperature of the control circuit 30 is raised excessively to reach the preset temperature value (ranged between 115° C. and 130° C.), the protection device 40 is operated to interrupt the connection between the input terminal 23 of the base 20 and the control circuit 30 and to shut the electric power supplied to the control circuit 30 so as to stop operation of the fluorescent tube 10 and to prevent the control circuit 30 from producing overheat, thereby protecting and preventing the rectifier 31 and the power converter 32 of the control circuit 30 from being worn out or broken due to an overheat.

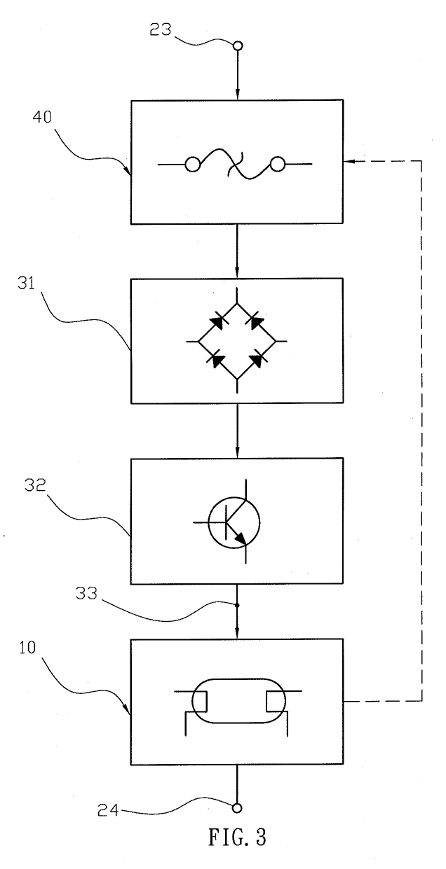

As shown in FIG. 3, the protection device 40 is a heating fuse.

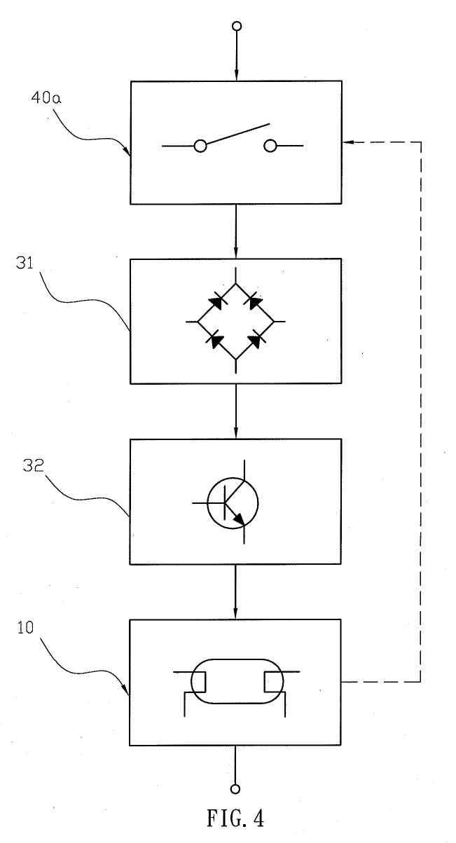

As shown in FIG. 4, the protection device 40a is a heat fused switch.

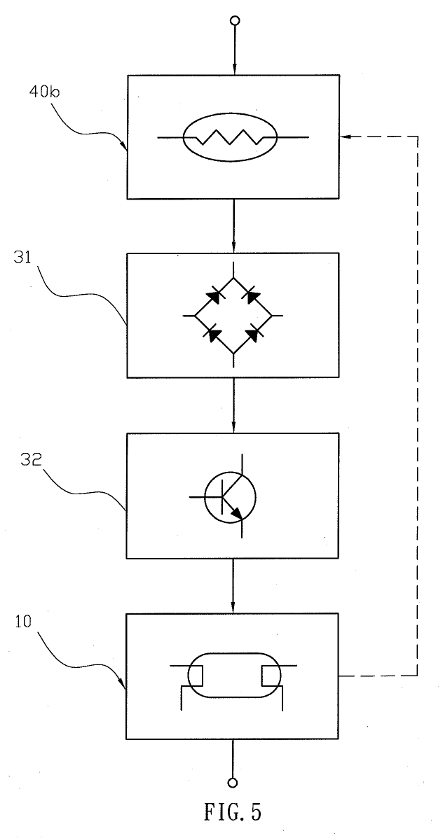

As shown in FIG. 5, the protection device 40b is a heat sensitive resistor.

Accordingly, when the temperature of the control circuit 30 is raised excessively to reach the preset temperature value due to an overheat of the fluorescent tube 10, the protection device 40 is operated to interrupt the connection between the input terminal 23 of the base 20 and the control circuit 30 and to shut the electric power supplied to the control circuit 30 so as to stop operation of the fluorescent tube 10 and to prevent the control circuit 30 from producing overheat, thereby protecting and preventing the rectifier 31 and the power converter 32 of the control circuit 30 from being worn out or broken due to an overheat. In addition, the protection device 40 can protect the control circuit 30 to prevent the control circuit 30 from being burned so as to protect the user's safety and to save the costs of maintenance.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A fluorescent lamp, comprising:
a base;
a control circuit mounted in the base;
a fluorescent tube electrically connected with the control circuit;
a protection device electrically connected with the control circuit and operable to shut an electric power supplied to the control circuit when a temperature of the control circuit is raised to reach a preset temperature value so as to stop operation of the fluorescent tube.

2. The fluorescent lamp of claim 1, wherein
the base includes an input terminal and an output terminal;
the protection device is electrically connected between the input terminal of the base and the control circuit.

3. The fluorescent lamp of claim 2, wherein the control circuit is electrically connected between the protection device and the fluorescent tube.

4. The fluorescent lamp of claim 3, wherein the fluorescent tube is electrically connected between the control circuit and the output terminal of the base.

5. The fluorescent lamp of claim 3, wherein the control circuit includes:
a rectifier electrically connected with the protection device;
a power converter electrically connected between the rectifier and the fluorescent tube.

6. The fluorescent lamp of claim 5, wherein the protection device is electrically connected between the input terminal of the base and the rectifier of the control circuit.

7. The fluorescent lamp of claim 5, wherein the control circuit has a connecting terminal electrically connected with the fluorescent tube.

8. The fluorescent lamp of claim 7, wherein the connecting terminal of the control circuit is electrically connected between the power converter and the fluorescent tube.

9. The fluorescent lamp of claim 1, wherein the preset temperature value of the control circuit is ranged between 115° C. and 130° C.

10. The fluorescent lamp of claim 1, wherein the protection device is mounted on the control circuit.

11. The fluorescent lamp of claim 1, wherein the protection device is a heat sensitive switch.

12. The fluorescent lamp of claim 11, wherein the protection device is a heating fuse.

13. The fluorescent lamp of claim 11, wherein the protection device is a heat fused switch.

14. The fluorescent lamp of claim 11, wherein the protection device is a heat sensitive resistor.

15. The fluorescent lamp of claim 5, wherein when the temperature of the control circuit is raised to reach the preset temperature value, the protection device is operable to interrupt a connection between the input terminal of the base and the control circuit and to shut the electric power supplied to the control circuit so as to stop operation of the fluorescent tube and to prevent the control circuit from producing overheat, thereby protecting the rectifier and the power converter of the control circuit.

16. The fluorescent lamp of claim 7, further comprising:
a lamp shade mounted on the base to cover the fluorescent tube.

17. The fluorescent lamp of claim 16, wherein
the fluorescent tube is mounted inside of the lamp shade;
the control circuit is mounted outside of the lamp shade and is located between the lamp shade and the base;
the connecting terminal of the control circuit is mounted inside of the lamp shade;
the protection device is located between the lamp shade and the base.
